(19) United States
(12) Patent Application Publication
(10) Pub. No.: US 2023/0037602 A1
(43) Pub. Date: Feb. 9, 2023

(54) INFORMATION PROCESSING METHOD AND APPARATUS, NODE DEVICE, SERVER AND STORAGE MEDIUM

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventor: Liuyan HAN, Beijing (CN)

(21) Appl. No.: 17/790,241

(22) PCT Filed: Dec. 30, 2020
(86) PCT No.: PCT/CN2020/141648

§ 371 Date: Jun. 30, 2022

(30) Foreign Application Priority Data
Jan. 2, 2020 (CN) 202010002178.5

(51) Int. Cl. H04L 43/026; H04L 43/04

(52) U.S. Cl. CPC H04L 43/026; H04L 43/04

(57) ABSTRACT

The embodiments of the present disclosure provide a method and apparatus for information processing, a node device, a server and a storage medium. The method includes that: characteristic information is extracted from an acquired service packet; and the characteristic information is sent to a server, so that the server generates, according to the characteristic information, a detection instance for detecting a service flow corresponding to the service packet. Thus, by extracting the characteristic information of the service packet, the server generates a detection instance corresponding to the characteristic information, achieving the flexible deployment and application of channel associated performance detection, and reducing the difficulty and cost of manual maintenance.

### CROSS-REFERENCE TO RELATED APPLICATION

The present disclosure is based upon and claims priority to Chinese Patent Application No. 202010002178.5, filed on Jan. 2, 2020, the disclosure of which is hereby incorporated by reference in its entirety.

### TECHNICAL FIELD

The present disclosure relates to network communication technologies, and relates to, but is not limited to, a method and apparatus for information processing, a node device, a server and a storage medium.

### BACKGROUND

An important characteristic of telecommunication level transmission technologies is the Operation Administration and Maintenance (OAM) capability, which provides alarm, performance detection, etc. to ensure that faults can be found in time. The real-time performance detection is very important for network operation and maintenance. The OAM function is classified into out-of-band OAM and channel associated OAM. The out-of-band OAM refers to detecting connectivity, packet loss, and delay in other ways, such as generating a special OAM packet, rather than directly detecting through a service packet. The channel associated OAM is detecting directly through a service packet. The channel associated performance detection is detecting at the entry of a service, that is, detecting all types of accessing packets at a User Network Interface (UNI) of a device. Base stations, special lines of government and enterprise, local area networks and other customers may access the UNI of a device. Because other devices or networks accessing the UNI of a device do not belong to a management and control domain where a channel associated performance detection device resides, it is necessary to manually acquire service information of the customer before configuring it for channel associated performance detection. When the service information changes, it is necessary to manually configure it. Therefore, there are problems that the deployment and maintenance of channel associated performance detection is difficult, and the application is not flexible.

### SUMMARY

Embodiments of the present disclosure provide a method and apparatus for information processing, a node device, a server and a storage medium, which can achieve the flexible deployment and application of channel associated performance detection.

A technical solution in the embodiments of the application is implemented as follows.

The embodiments of the present disclosure provide a method for information processing, which is applied to a node device and may include the following operations.

Characteristic information is extracted from an acquired service packet.

The characteristic information is sent to a server, so that the server generates, according to the characteristic information, a detection instance for detecting a service flow corresponding to the service packet.

The embodiments of the present disclosure provide a method for information processing, which is applied to a server and may include the following operations.

Characteristic information sent by a node device is acquired.

Based on the characteristic information, a detection instance for detecting a service flow corresponding to a service packet is generated.

The embodiments of the present disclosure provide an apparatus for information processing, which may include: a first extracting module and a first sending module.

The first extracting module is configured to extract the characteristic information from the acquired service packet.

The first sending module is configured to send the characteristic information to the server, so that the server generates, according to the characteristic information, a detection instance for detecting the service flow corresponding to the service packet.

The embodiments of the present disclosure provide an apparatus for information processing, which may include: a first acquiring module and a first determining module.

The first acquiring module is configured to acquire the characteristic information sent by the node device.

The first determining module is configured to generate, based on the characteristic information, a detection instance for detecting the service flow corresponding to the service packet.

The embodiments of the present disclosure provide a node device, which may include at least a controller and a storage medium configured to store an executable instruction.

The controller is configured to execute the stored executable instruction, and the executable instruction is configured to execute the information processing method.

The embodiments of the present disclosure provide a server, which may include at least a controller and a storage medium configured to store an executable instruction.

The controller is configured to execute the stored executable instruction, and the executable instruction is configured to execute the information processing method.

The embodiments of the present disclosure provide a computer-readable storage medium having stored thereon computer-executable instructions. The computer-executable instructions are configured to execute the information processing method.

The embodiments of the present disclosure provide a method and apparatus for information processing, a node device, a server and a storage medium. First, a characteristic information set is extracted from multiple acquired service packets; and then the characteristic information set is sent to a server, so that the server generates, according to the characteristic information set, a detection instance set for detecting multiple service flows corresponding to the multiple service packets. In this way, by extracting the characteristic information of the service packet passing through the entry of the node device, the server generates a detection instance corresponding to the characteristic information, and the service flow corresponding to the characteristic information is detected based on the detection instance, achieving the flexible deployment and application of channel associated performance detection.

### BRIEF DESCRIPTION OF THE DRAWINGS

FIG. 1 is an implementation flowchart of a method for information processing according to an embodiment of the present disclosure.

FIG. 2 is another implementation flowchart of a method for information processing according to an embodiment of the present disclosure.

FIG. 3 is yet another implementation flowchart of a method for information processing according to an embodiment of the present disclosure.

FIG. 4 is yet another implementation flowchart of a method for information processing according to an embodiment of the present disclosure.

FIG. 5 is an interactive diagram of a method for information processing according to an embodiment of the present disclosure.

FIG. 6 is a structural schematic diagram of an apparatus for information processing according to an embodiment of the present disclosure.

FIG. 7 is another structural schematic diagram of an apparatus for information processing according to an embodiment of the present disclosure.

FIG. 8 is a composition structure diagram of a node device according to an embodiment of the present disclosure.

FIG. 9 is a composition structure diagram of a server according to an embodiment of the present disclosure.

### DETAILED DESCRIPTION

It should be understood that the specific embodiments described here are only used for explaining the present disclosure, but not for limiting the present disclosure.

In the subsequent description, suffixes such as “module”, “part” or “unit” for denoting components are intended only to facilitate the description of the present disclosure and has no specific meaning of its own. Thus, “module,” “part,” or “unit” can be mixed.

Terminals may be implemented in various forms. For example, terminals described in the present disclosure may include a mobile phone, a tablet PC, a laptop, a Personal Digital Assistant (PDA), a Portable Media Player (PMP), a navigation device, a wearable terminal, a smart bracelet, a pedometer and other mobile terminals, as well as fixed terminals such as a digital TV and a desktop computer.

The subsequent description will take mobile terminals as an example. Those skilled in the art will understand that except a component used especially for mobile purposes, the construction according to the embodiments of the present disclosure can also be applied to a fixed terminal.

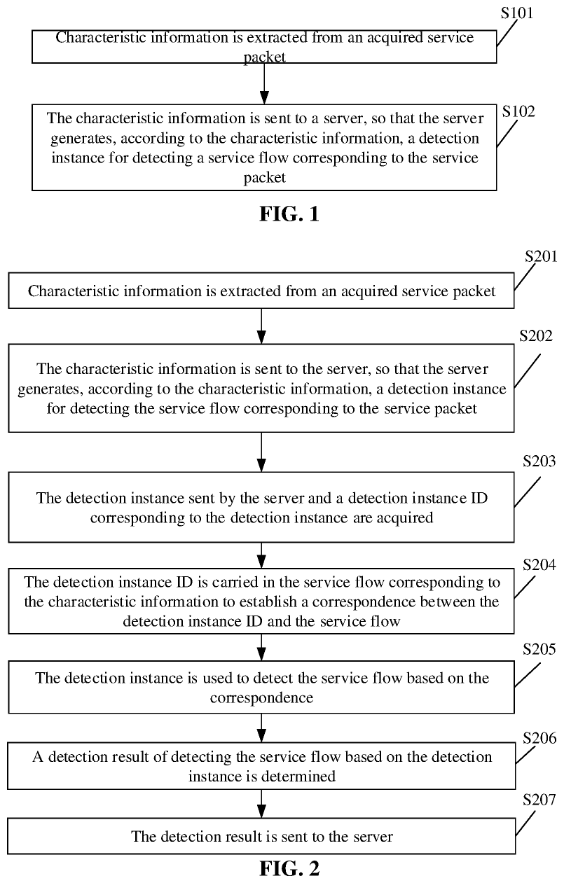

The embodiments of the present disclosure provide a method for information processing, which is applied to a node device. FIG. 1 is an implementation flowchart of a method for information processing according to an embodiment of the present disclosure. As illustrated in FIG. 1, the information processing method may include the following steps.

At S101, characteristic information is extracted from an acquired service packet.

Here, the service packet refers to one or multiple service packets that pass through a node device in a period of time. One service packet corresponds to one piece of characteristic information, and multiple service packets correspond to multiple pieces of characteristic information, correspondingly forming a characteristic information set. An object of channel associated performance detection is a service flow. Different layer-2 and layer-3 service flows may be detected. The node device acquires a service packet at the entry, and extracts the characteristic information required for channel associated performance detection from the packet. The characteristic information set may be obtained by extracting the characteristic information from multiple service packets. In a specific example, if the service packet is a layer-2 service packet, the extracted characteristic information may include one or more of a physical port, a Media Access Control (MAC) address, a Virtual Local Area Network (VLAN) and a VLAN priority; if the service packet is a layer-3 service packet, the extracted characteristic information may include one or more of a destination Internet Protocol (IP) address, a source IP address, a Differentiated Services Code Point (DSCP) priority, a source port and a destination port. The characteristic information is used for performing channel associated performance detection on the service flow.

At S102, the characteristic information is sent to a server, so that the server generates, according to the characteristic information, a detection instance for detecting a service flow corresponding to the service packet.

Here, after receiving the characteristic information sent by the node device, the server records and saves the characteristic information, and generates a detection instance for the characteristic information to perform channel associated performance detection on the service flow corresponding to the service packet corresponding to the characteristic information. If the server receives the characteristic information set, after receiving the characteristic information set sent by the node device, the server records and saves the characteristic information set, and generates the corresponding detection instance for each piece of characteristic information in the characteristic information set to perform channel associated performance detection on the service flow corresponding to the service packet corresponding to each piece of characteristic information. The detection instances corresponding to each piece of characteristic information form the detection instance set. In some possible implementations, the server may be a centralized detection unit. The centralized detection unit may be integrated with the network management, controller and other devices together, and may also be an independent device dedicated to centralized network detection.

In a specific example, the server receives the characteristic information set sent by the node device. The characteristic information set includes three pieces of characteristic information as follows.

Characteristic information 1: the source IP is AAA, and the destination IP is BBB.

Characteristic information 2: the source IP is CCC, and the destination IP is DDD.

Characteristic information 3: the source IP is EEE, and the destination IP is FFF.

Based on these characteristic information, the server generates three detection instances X, Y, and Z, which are respectively used for detecting three service flows to which the service packets corresponding to the three pieces of characteristic information belong. The three detection instances form a detection instance set.

Alternatively, if the server decides, based on these characteristic information, to detect only the service flow corresponding to the characteristic information about the destination IP is BBB, the server generates a detection instance X.

In some possible implementations, after the server generates a detection instance or detection instance set, the server sends the detection instance or detection instance set to the node device for the subsequent channel associated performance detection.

In the embodiments of the present disclosure, by extracting the characteristic information of the service packet passing through the entry of the node device, the server may generate a detection instance corresponding to the characteristic information, so that the node device may detect the service flow corresponding to the characteristic information according to the detection instance, achieving the flexible deployment and application of channel associated performance detection, and reducing the difficulty and cost of manual maintenance.

The embodiments of the present disclosure provide a method for information processing, which may extract the characteristic information according to a policy sent by the server. The method may be implemented by the following steps.

At S111, a policy which is sent by the server for extracting the service flow corresponding to the service packet is acquired.

Here, the node device may receive and execute the policy sent by the server. The policy is sent by the server to the node device for extracting the service flow corresponding to the service packet. The policy may also be used for extracting multiple service flows corresponding to multiple service packets. Each service flow corresponds to one service packet. Moreover, the policy may be set and modified for different node devices and then sent to different node devices.

In a specific example, the server may send different kinds of policies to the node device, so that the node device can extract different characteristic information according to the different kinds of policies.

At S112, based on the policy, the characteristic information is extracted from the acquired service packet.

Here, after receiving the policy, the node device extracts the characteristic information matching the policy from the acquired service packet based on the policy. If multiple service packets are acquired, the characteristic information corresponding to each service packet is extracted to obtain the characteristic information set.

In a specific example, S202 may be implemented in several following manners.

In a first manner, if the policy is extracting the service flow whose destination IP address is xxx.xxx.xxx.xxx, the node device extracts the characteristic information from the corresponding service flow whose destination IP address is xxx.xxx.xxx.xxx in the acquired service packet.

In a second manner, if the policy is extracting the service flow whose DSCP priority is xxx, the node device extracts the characteristic information from the corresponding service flow whose DSCP priority is xxx in the acquired service packet.

In a third manner, if the policy is extracting the destination IP address and the source IP address, the node device extracts the characteristic information of the destination IP address and the source IP address from acquired service packet.

In this way, the node device may pointedly extract specific characteristic information according to the policy sent by the server, so as to perform channel associated performance detection on the specific service flow.

In some possible implementations, the node device extracts the characteristic information from the acquired service packet according to a preset cycle. In a specific example, the preset cycle may be set to every five seconds, that is, the node device acquires the service packet every five seconds and then extracts the characteristic information from the acquired service packet.

At S113, the characteristic information is sent to the server, so that the server generates, according to the characteristic information set, a detection instance for detecting the service flow corresponding to the service packet.

In the embodiments of the present disclosure, the node device may pointedly extract the specific characteristic information according to the policy sent by the server, and detect the specific service flow according to the detection instance of the specific characteristic information, achieving targeted channel associated performance detection on the service flow, and achieving the flexible deployment and application of channel associated performance detection.

In some embodiments, after S113, the method may further include the following process.

The detection instance is acquired, and the service flow is detected based on the detection instance. Here, the node device acquires the detection instance or detection instance set sent by the server, determines the characteristic information corresponding to each detection instance according to the detection instance or each detection instance in the detection instance set, then determines the service packet corresponding to each detection instance according to the characteristic information, and finally determines the service flow corresponding to each detection instance. In this way, the detection instance or the detection instance in the detection instance set is used to detect the corresponding service flow.

The embodiments of the present disclosure provide a method for information processing. To prevent the node device from sending repeated characteristic information to the server, the method may be implemented by the following steps.

At S121, characteristic information is extracted from an acquired service packet.

At S122, if the characteristic information is not included in a characteristic information base, the characteristic information is sent to the server, so that the server generates, according to the characteristic information, a detection instance for detecting the service flow corresponding to the service packet.

Here, after extracting the characteristic information, the node device stores the characteristic information and generates a characteristic information base. After extracting the characteristic information next time, the node device compares the characteristic information with the characteristic information of the characteristic information base to determine whether characteristic information is included in the characteristic information base. If the characteristic information is not included in a characteristic information base, the characteristic information is sent to the server, so that the server generates, according to the characteristic information, a detection instance for detecting the service flow corresponding to the service packet. If the characteristic information is included in the characteristic information base, the characteristic information is not sent to the server.

In the embodiments of the present disclosure, by comparing the characteristic information extracted by node device with the characteristic information in the characteristic information base, whether a characteristic information set is included in the characteristic information base can be determined. If the characteristic information is not included in the characteristic information base, candidate characteristic information is sent to the server. In this way, the repeated characteristic information in the characteristic information set extracted by the node device and the characteristic information database can be filtered to avoid sending the repeated characteristic information to the server.

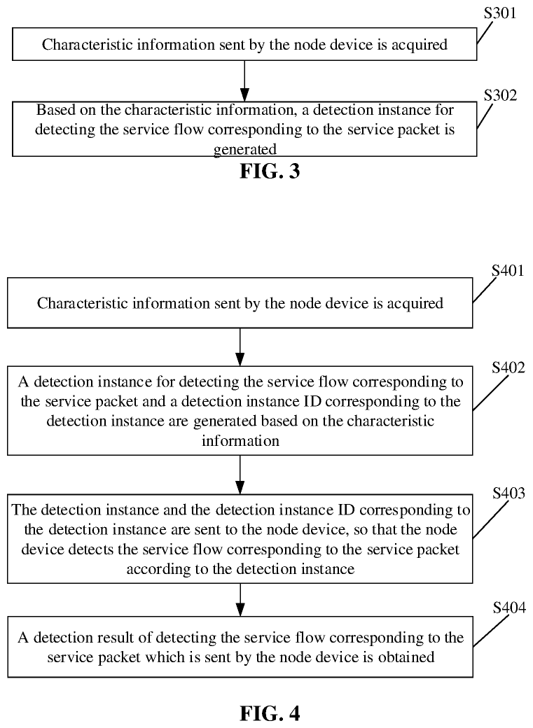

The embodiments of the present disclosure provide a method for information processing, which is applied to a node device. FIG. 2 is another implementation flowchart of a method for information processing according to an embodiment of the present disclosure. As illustrated in FIG. 2, the information processing method may include the following steps.

At S201, characteristic information is extracted from an acquired service packet.

At S202, the characteristic information is sent to the server, so that the server generates, according to the characteristic information, a detection instance for detecting the service flow corresponding to the service packet.

At S203, the detection instance sent by the server and a detection instance ID corresponding to the detection instance are acquired.

Here, after receiving the characteristic information sent by the node device, the server generates a corresponding detection instance and detection instance ID according to the characteristic information. The detection instance and the detection instance ID and the characteristic information are in one-to-one correspondence. Then, the server sends the detection instance and the detection instance ID corresponding to the detection instance to the node device.

In some possible implementations, if the server receives a characteristic information set, it generates the corresponding detection instance and detection instance ID according to each piece of characteristic information in the characteristic information set. Then, the server sends the detection instance set and the detection instance ID corresponding to each detection instance in the detection instance set to the node device.

At S204, the detection instance ID is carried in the service flow corresponding to the characteristic information to establish a correspondence between the detection instance ID and the service flow.

Here, after acquiring the detection instance or the detection instance set, the node device carries the detection instance ID in the service flow corresponding to the characteristic information according to the correspondence between the detection instance and the characteristic information. In a specific example, the detection instance ID may be encapsulated in the service packet of the service flow corresponding to the characteristic information, so that the correspondence between the detection instance ID and the service flow is established.

At S205, the detection instance is used to detect the service flow based on the correspondence.

Here, after the correspondence between the detection instance ID and the service flow is established, the node device uses the detection instance to detect the network connectivity, packet loss, or delay of the service flow corresponding to the detection instance ID.

S203 to S205 realize the operation process where the node device acquires the detection instance, and detects the service flow based on the detection instance.

At S206, a detection result of detecting the service flow based on the detection instance is determined.

Here, the detection instance may be the detection instance set, correspondingly, after detecting the corresponding service flow according to the detection instance in the detection instance set, the node device obtains multiple detection results which generate a detection result set.

At S207, the detection result is sent to the server.

In the embodiments of the present disclosure, the node device acquires the detection instance generated by the server and the detection instance ID corresponding to the detection instance, establishes the correspondence between the service flow corresponding to the characteristic information and the detection instance, and carries the correspondence in the corresponding service flow. In this way, the one-to-one correspondence between the detection instance and the service flow is realized, and the detection result can be sent to the server according to the correspondence, achieving the targeted deployment and application of channel associated performance detection.

In some embodiments, after S202, the method may further include the following process.

after sending the characteristic information to the server, the node device may also set expiration time of the characteristic information, that is, if no service packet corresponding to the characteristic information is received within the preset time, the state of the characteristic information is determined to be an invalid time, and information about the invalid state of the characteristic information is sent to the server.

The embodiments of the present disclosure provide a method for information processing, which is applied to a server. FIG. 3 is another implementation flowchart of a method for information processing according to an embodiment of the present disclosure. As illustrated in FIG. 3, the information processing method may include the following steps.

At S301, characteristic information sent by the node device is acquired.

Here, the characteristic information sent by the node may be an information set composed of multiple pieces of characteristic information.

At S302, based on the characteristic information, a detection instance for detecting the service flow corresponding to the service packet is generated.

Here, after acquiring the characteristic information sent by the node device, the server records the characteristic information, generates a required detection instance for channel associated performance detection according to the characteristic information, and sends the detection instance to the node device. Correspondingly, if the characteristic information is the characteristic information set, a detection instance set is generated.

In the embodiments of the present disclosure, by acquiring the characteristic information sent by the node device, a detection instance for detecting the service flow corresponding to the service packet can be generated, achieving the generation of detection instance according to real-time requirements, achieving the flexible deployment and application of channel associated performance detection, and reducing the difficulty and cost of manual maintenance.

The embodiments of the present disclosure provide a method for information processing, in which the server may send a policy for extracting the service flow corresponding to the service packet to the node device, and the node device extracts the corresponding characteristic information according to the policy. The method may be implemented by the following steps.

At S311, a policy for extracting the service flow corresponding to the service packet is sent, so that the node device extracts the characteristic information of the service packet matching the policy.

Here, the policy is extracting a constraint of the characteristic information or extracting a service matching the characteristic information. In addition, the policy may also be flexibly sent or modified for different node devices.

At S312, characteristic information sent by the node device is acquired.

At S313, based on the characteristic information, a detection instance for detecting the service flow corresponding to the service packet is generated.

In the embodiments of the present disclosure, by sending the policy for acquiring the matching service packet to the node device, the node device can extract the characteristic information of the service packet matching the policy, achieving targeted characteristic extraction on the service flow, and achieving targeted channel associated performance detection on the service flow.

The embodiments of the present disclosure provide a method for information processing, which is applied to a server. FIG. 4 is another implementation flowchart of a method for information processing according to an embodiment of the present disclosure. As illustrated in FIG. 4, the information processing method may include the following steps.

At S401, characteristic information sent by the node device is acquired.

At S402, a detection instance for detecting the service flow corresponding to the service packet and a detection instance ID corresponding to the detection instance are generated based on the characteristic information.

At S403, the detection instance and the detection instance ID corresponding to the detection instance are sent to the node device, so that the node device detects the service flow corresponding to the service packet according to the detection instance.

At S404, a detection result of detecting the service flow corresponding to the service packet which is sent by the node device is obtained.

In the embodiments of the present disclosure, the service generates the detection instance and the detection instance ID corresponding to the detection instance based on the characteristic information, establishes the correspondence between the service flow corresponding to the characteristic information and the detection instance, realizing the one-to-one correspondence between the detection instance and the service flow, and may obtain, according to the correspondence, the detection result of detecting the service flow which is sent by the node device, achieving the targeted deployment and application of channel associated performance detection.

In some embodiments, after S401, the method may further include the following process.

If the state of the characteristic information is the invalid state, the characteristic information and the detection instance ID of the detection instance corresponding to the characteristic information are deleted.

Here, when the server receives the information about the invalid state of the characteristic information sent by the node device, it deletes the characteristic information from the record of the characteristic information. If the server has generated and sent the detection instance for the service flow corresponding to the characteristic information, the server deletes the detection instance ID corresponding to the detection instance, and does not detect the service flow corresponding to the characteristic information.

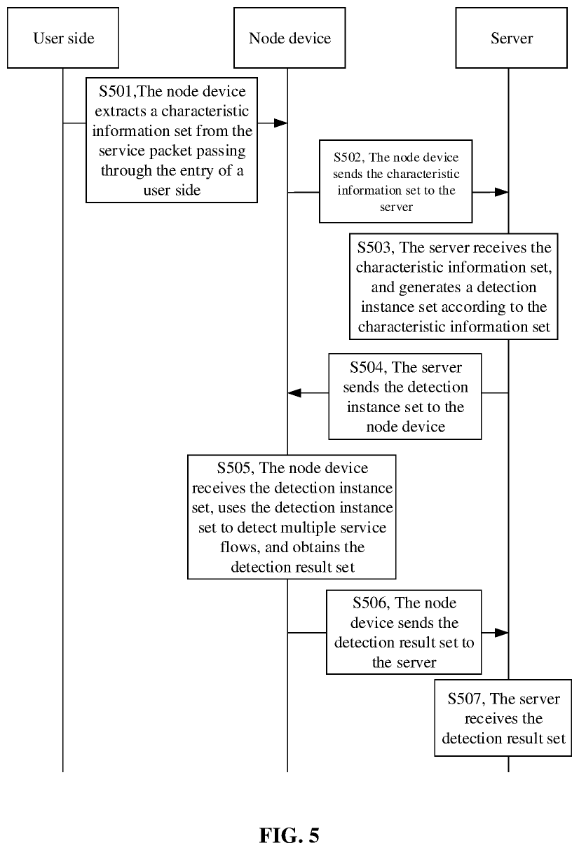

The embodiments of the present disclosure provide a method for information processing. FIG. 5 is an interactive diagram of a method for information processing according to an embodiment of the present disclosure. The information processing method is described in combination with the steps illustrated in FIG. 5.

At S501, the node device extracts a characteristic information set from the service packet passing through the entry of a user side.

Here, in a specific example, if the packet is the layer-2 service packet, the extracted characteristic information set may include one or more of a physical port, an MAC address, a VLAN, and a VLAN priority; if the packet is the layer-3 service packet, the extracted characteristic information set may include one or more of a destination IP address, a source IP address, a DSCP priority, a source port and a destination port. The characteristic information set is used for performing channel associated performance detection on the service flow.

In the embodiments of the present disclosure, the characteristic information may be extracted in any of the following manners.

First manner, the node device extracts the characteristic information set according to the policy for extracting the characteristic information sent by the server. The policy may be multiple different policies. In a specific example, if policy 1 is extracting only the service flow of a certain destination IP address, the device extracts the characteristic information only from the detected service flow with the destination IP address; if policy 2 is extracting only the service flow whose DSCP priority is high, the node device extracts the characteristic information only from the detected service flow whose DSCP priority is high; if policy 3 is extracting only the destination IP address and the source IP address, the node device extracts only the destination IP address and the source IP address of the service flow passing through the device. The policy may be set and modified for different node devices and then sent to different node devices.

Second manner, the node device may extract the characteristic information of the packet according to a cycle. In a specific example, the characteristic information is extracted from the service packet every five seconds to obtain the characteristic information set.

In the embodiments of the present disclosure, based on the policy for extracting the characteristic information sent by the server, the node device may extract the characteristic information set of the service packet at the entry of the user side, or extract the characteristic information set matching the service packet from the service packet according to the preset cycle for channel associated performance detection.

At S502, the node device sends the characteristic information set to the server.

At S503, the server receives the characteristic information set, and generates a detection instance set according to the characteristic information set.

Here, after receiving the characteristic information set, the server generates a detection instance corresponding to each piece of characteristic information in the characteristic information set. At the same time, the server sets the corresponding detection instance ID for each detection instance.

In the embodiments of the present disclosure, the server generates a detection instance based on the characteristic information, and sets the detection instance ID corresponding to the detection instance to detect the corresponding service flow.

At S504, the server sends the detection instance set to the node device.

In the embodiments of the present disclosure, the server sends the detection instance and detection instance ID to the node device. The node device may carry a service flow detection ID in the corresponding service flow to implement the targeted detection on the service flow.

At S505, the node device receives the detection instance set, uses the detection instance set to detect multiple service flows, and obtains the detection result set.

Here, after acquiring the detection instance set, the node device carries the detection instance ID in the service flow corresponding to the characteristic information according to the correspondence between the detection instance and the characteristic information in the detection instance set. In a specific example, the detection instance ID may be encapsulated in the service packet of the service flow corresponding to the characteristic information, so that the correspondence between the detection instance ID and the service flow is established. Based on the correspondence, after using the detection instance in the detection instance set to detect the corresponding service flow, the node device obtains multiple detection results which generate the detection result set.

At S506, the node device sends the detection result set to the server.

At S507, the server receives the detection result set.

In the embodiments of the present disclosure, by receiving and analyzing the detection result set sent by the node device, the server can perform real-time performance detection on the running state of the current network. The node device extracts the characteristic information in the service packet and sends the characteristic information to the server; based on the characteristic information, the server generates the detection instance set and the detection instance ID corresponding to the detection instance; and the node device detects the corresponding service flow according to the detection instance and the detection instance ID. In this way, without acquiring service information in advance, the flexible deployment and application of channel associated performance detection is achieved, and the maintenance difficulty of channel associated performance detection is simplified.

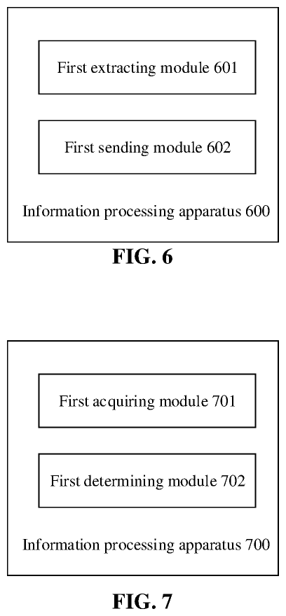

The embodiments of the present disclosure provide an apparatus for information processing. FIG. 6 is a structural schematic diagram of an apparatus for information processing according to an embodiment of the present disclosure. As illustrated in FIG. 6, the apparatus 600 may include: a first extracting module 601 and a first sending module 602.

The first extracting module 601 is configured to extract the characteristic information from the acquired service packet.

The first sending module 602 is configured to send the characteristic information to the server, so that the server generates, according to the characteristic information, a detection instance for detecting the service flow corresponding to the service packet.

The apparatus may also include: a second acquiring module and a second extracting module.

The second acquiring module is configured to acquire the policy which is sent by the server for extracting the service flow corresponding to the service packet.

The second extracting module is configured to extract the characteristic information from the acquired service packet based on the policy.

In the above apparatus, the first extracting module 601 is further configured to extract the characteristic information from the acquired service packet according to the preset cycle.

In the above apparatus, the first sending module 602 is further configured to: if the characteristic information is not induced in the characteristic information base, send the characteristic information to the server, so that the server generates, according to the characteristic information, a detection instance for detecting the service flow corresponding to the service packet.

The apparatus may also include: a second determining module and a second sending module.

The second determining module is configured to: if the service packet corresponding to the characteristic information is not received in a preset time, determine the state of the characteristic information to be the invalid state.

The second sending module is configured to send the information that the state of the characteristic information is the invalid state to the server.

The apparatus may also include: a third acquiring module and a detecting module.

The third acquiring module is configured to acquire the detection instance.

The detecting module is configured to detect the service flow based on the detection instance.

In the above apparatus, the detecting module may include: an acquiring submodule, an establishing submodule and a detecting submodule.

The acquiring submodule is configured to acquire the detection instance sent by the server and the detection instance ID corresponding to the detection instance.

The establishing submodule is configured to carry the detection instance ID in the service flow corresponding to the characteristic information to establish the correspondence between the detection instance ID and the service flow.

The detecting submodule is configured to use the detection instance to detect the service flow based on the correspondence.

In the above apparatus, the detecting module may also include: a determining submodule and a first sending submodule.

The determining submodule is configured to determine the detection result of detecting the service flow based on the detection instance.

The first sending submodule is configured to send the detection result to the server.

The embodiments of the present disclosure provide another information processing apparatus. FIG. 7 is another structural schematic diagram of an apparatus for information processing according to an embodiment of the present disclosure. As illustrated in FIG. 7, the apparatus 700 may include: a first acquiring module 701 and a first determining module 702.

The first acquiring module 701 is configured to acquire the characteristic information sent by the node device.

The first determining module 702 is configured to generate, based on the characteristic information, a detection instance for detecting the service flow corresponding to the service packet.

The apparatus may also include: a third sending module.

The third sending module is configured to send the policy for extracting the service flow corresponding to the service packet, so that the node device extracts the characteristic information of the service packet matching the policy.

The apparatus may also include that:

the policy includes extracting the constraint of the characteristic information or extracting the service matching the characteristic information.

In the above apparatus, the first determining module 702 is further configured to generate the detection instance ID corresponding to the detection instance based on the characteristic information.

In the above apparatus, the first determining module 702 may include: a second sending submodule.

The second sending submodule is configured to send the detection instance and the detection instance ID corresponding to the detection instance to the node device, so that the node device detects the service flow corresponding to the service packet according to the detection instance.

The apparatus may also include a deleting module.

The deleting module is configured to: if the state of the characteristic information is the invalid state, delete the characteristic information and the detection instance ID of the detection instance corresponding to the characteristic information.

In the above apparatus, the first acquiring module 701 is further configured to acquire the detection result of detecting the service flow corresponding to the service packet which is sent by the node device.

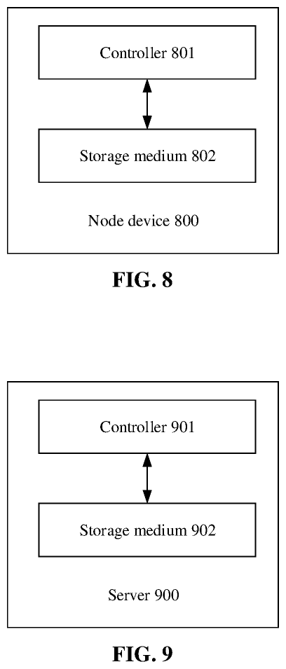

The embodiments of the present disclosure provide a node device. FIG. 8 is a composition structure diagram of a node device according to an embodiment of the present disclosure. As illustrated in FIG. 8, the node device 800 may include at least a controller 801 and a storage medium 802 configured to store an executable instruction.

The controller 801 is configured to execute the stored executable instruction, and the executable instruction is configured to implement the provided information processing method.

The embodiments of the present disclosure provide a server. FIG. 9 is a composition structure diagram of a server according to an embodiment of the present disclosure. As illustrated in FIG. 9, the server 900 may include at least a controller 901 and a storage medium 902 configured to store an executable instruction.

The controller 901 is configured to execute the stored executable instruction, and the executable instruction is configured to implement the provided information processing method.

It is to be noted that the above descriptions about the terminal embodiments are similar to descriptions about the method embodiments and beneficial effects similar to those of the method embodiments are achieved. Technical details undisclosed in the terminal embodiments of the present disclosure may be understood with reference to the descriptions about the method embodiments of the present disclosure.

Correspondingly, an embodiment of the present disclosure provides a computer storage medium storing a computer-executable instruction. The computer-executable instruction is configured to perform the information processing method provided in other embodiments of the present disclosure.

It is to be noted that terms “include” and “contain” or any other variant thereof is intended to cover nonexclusive inclusions herein, so that a process, method, object or device including a series of components not only includes those components but also includes other components which are not clearly listed or further includes components intrinsic to the process, the method, the object or the device. Under the condition of no more limitations, a component defined by the statement “including a/an” does not exclude existence of the same other components in a process, method, object or device including the component.

The sequence numbers of the embodiments of the present disclosure are just for describing, instead of representing superiority-inferiority of the embodiments.

Through the above description of the implementations, those skilled in the art may clearly know that the method according to the above embodiments may be implemented by means of software plus a necessary common hardware platform, certainly by means of hardware; but in many cases, the former is the better implementation. Based on this understanding, the technical solution of the present disclosure substantially or the part making a contribution to the conventional art can be embodied in the form of software product; the computer software product is stored in a storage medium (for example, an ROM/an RAM, a magnetic disk, and a compact disc) and includes a number of instructions to make a terminal device (which can be a cell phone, a personal computer, a server, etc.) perform all or part of the method in each embodiment of the present disclosure.

The present disclosure is described with reference to flowcharts and/or block diagrams of the method, the terminal (system) and the computer program product according to the embodiments of the present disclosure. It is to be understood that each flow and/or block in the flowcharts and/or the block diagrams and combinations of the flows and/or blocks in the flowcharts and/or the block diagrams may be implemented by computer program instructions. These computer program instructions can be provided to a processor of a general-purpose computer, a special-purpose computer, an embedded processor or other programmable data processing terminals to generate a machine, so that instructions which are executed by the processor of the computer or other programmable data processing terminals generate a device which is used for implementing the specified functions in one or more flows of the flowchart and/or one or more blocks of the block diagram.

These computer program instructions may also be stored in the computer-readable memory which can guide the computer or other programmable data processing terminals to work in a particular way, so that the instructions stored in the computer-readable memory generate a product including an instruction device. The instruction device implements the specified functions in one or more flows of the flowchart and/or one or more blocks of the block diagram.

These computer program instructions may also be loaded on the computer or other programmable data processing terminals, so that a series of operation steps are performed on the computer or other programmable terminals to generate the processing implemented by the computer, and the instructions executed on the computer or other programmable terminals provide the steps for implementing the specified functions in one or more flows of the flowchart and/or one or more blocks of the block diagram.

The above is only the preferred embodiments of the present disclosure, not limiting the scope of patent protection of the present disclosure; all equivalent structures or equivalent process transformations made through the contents of the specification and accompanying drawings of the present disclosure or directly or indirectly applied to other related technical field are similarly included in the scope of patent protection of the present disclosure.

### INDUSTRIAL APPLICABILITY

The embodiments of the present disclosure provide a method for information processing and apparatus, a node device, a server and a storage medium. The method includes that: characteristic information is extracted from an acquired service packet; and the characteristic information is sent to a server, so that the server generates, according to the characteristic information, a detection instance for detecting a service flow corresponding to the service packet. Thus, by extracting the characteristic information of the service packet, the server generates a detection instance corresponding to the characteristic information, achieving the flexible deployment and application of channel associated performance detection, and reducing the difficulty and cost of manual maintenance.

1. A method for information processing, applied to a node device, comprising:
extracting characteristic information from an acquired service packet; and
sending the characteristic information to a server, so that the server generates, according to the characteristic information, a detection instance for detecting a service flow corresponding to the service packet.

2. The method of claim 1, wherein before extracting the characteristic information from the acquired service packet, the method further comprises:
acquiring a policy which is sent by the server for extracting the service flow corresponding to the service packet;
correspondingly, based on the policy, the characteristic information is extracted from the acquired service packet.

3. The method of claim 1, wherein extracting the characteristic information from the acquired service packet comprises:
extracting the characteristic information from the acquired service packet according to a preset cycle.

4. The method of claim 1, wherein sending the characteristic information to the server, so that the server generates, according to the characteristic information, a detection instance for detecting the service flow corresponding to the service packet comprises:
when the characteristic information is not comprised in a characteristic information base, sending the characteristic information to the server, so that the server generates, according to the characteristic information, a detection instance for detecting the service flow corresponding to the service packet.

5. The method of claim 1, wherein after sending the characteristic information to the server, the method further comprises:
when the service packet corresponding to the characteristic information is not received in a preset time, determining a state of the characteristic information to be an invalid state; and
sending information that the state of the characteristic information is the invalid state to the server.

6. The method of claim 1, wherein after sending the characteristic information to the server, so that the server generates, according to the characteristic information, a detection instance for detecting the service flow corresponding to the service packet, the method further comprises:
acquiring the detection instance, and detecting the service flow based on the detection instance.

7. The method of claim 6, wherein acquiring the detection instance, and detecting the service flow based on the detection instance comprises:
acquiring the detection instance sent by the server and a detection instance identification (ID) corresponding to the detection instance;
carrying the detection instance ID in the service flow corresponding to the characteristic information to establish a correspondence between the detection instance ID and the service flow; and
detecting the service flow based on the correspondence by using the detection instance.

8. The method of claim 7, wherein after detecting the service flow based on the correspondence by using the detection instance, the method further comprises:
determining a detection result of detecting the service flow based on the detection instance; and
sending the detection result to the server.

9. A method for information processing, applied to a server, comprising:
acquiring characteristic information sent by a node device; and
generating a detection instance for detecting a service flow corresponding to a service packet based on the characteristic information.

10. The method of claim 9, wherein before acquiring the characteristic information sent by the node device, the method further comprises:
sending a policy for extracting the service flow corresponding to the service packet, so that the node device extracts the characteristic information of the service packet matching the policy.

11. The method of claim 10, wherein the policy comprises: extracting a constraint of the characteristic information or extracting a service matching the characteristic information.

12. The method of claim 9, wherein generating the detection instance for detecting the service flow corresponding to the service packet based on the characteristic information further comprises:
generating a detection instance identification (ID) corresponding to the detection instance based on the characteristic information.

13. The method of claim 12, wherein after generating the detection instance for detecting the service flow corresponding to the service packet, the method further comprises:
sending the detection instance and the detection instance ID corresponding to the detection instance to the node device, so that the node device detects the service flow corresponding to the service packet according to the detection instance.

14. The method of claim 9, wherein after acquiring the characteristic information sent by the node device, the method further comprises:
when a state of the characteristic information is an invalid state, deleting the characteristic information and a detection instance identification (ID) of the detection instance corresponding to the characteristic information.

15. The method of claim 9, wherein after sending the detection instance to the node device, so that the node device detects the service flow corresponding to multiple service packets according to the detection instance, the method further comprises:
acquiring a detection result, which is sent by the node device, of detecting the service flow corresponding to the service packet.

16.-17. (canceled)

18. A node device, at least comprising: a controller and a storage medium configured to store executable instructions; wherein
the controller is configured to execute the stored executable instructions to execute operations of:
extracting characteristic information from an acquired service packet; and
sending the characteristic information to a server, so that the server generates, according to the characteristic information, a detection instance for detecting a service flow corresponding to the service packet.

19.-20. (canceled)

21. The node device of claim 18, wherein the controller is further configured to execute the stored executable instructions to execute operations of:
before extracting the characteristic information from the acquired service packet, acquiring a policy which is sent by the server for extracting the service flow corresponding to the service packet;
correspondingly, based on the policy, the characteristic information is extracted from the acquired service packet.

22. The node device of claim 18, wherein extracting the characteristic information from the acquired service packet comprises:
extracting the characteristic information from the acquired service packet according to a preset cycle.

23. The node device of claim 18, wherein sending the characteristic information to the server, so that the server generates, according to the characteristic information, a detection instance for detecting the service flow corresponding to the service packet comprises:
when the characteristic information is not comprised in a characteristic information base, sending the characteristic information to the server, so that the server generates, according to the characteristic information, a detection instance for detecting the service flow corresponding to the service packet.

24. The node device of claim 18, wherein after sending the characteristic information to the server, the operations further comprises:
when the service packet corresponding to the characteristic information is not received in a preset time, determining a state of the characteristic information to be an invalid state; and
sending information that the state of the characteristic information is the invalid state to the server.
